(19) United States
(12) Patent Application Publication
(10) Pub. No.: US 2025/0224372 A1
(43) Pub. Date: Jul. 10, 2025

(54) TANDEM U-SHAPED ION MOBILITY SPECTROMETER AND ION MOBILITY ANALYSIS METHOD

(71) Applicant: SHIMADZU CORPORATION, Kyoto-shi (JP)

(72) Inventors: Xiaoqiang ZHANG, Shanghai (CN); Kang GUO, Shanghai (CN); Wenjian SUN, Shanghai (CN)

(21) Appl. No.: 19/013,890

(22) Filed: Jan. 8, 2025

(30) Foreign Application Priority Data
Jan. 8, 2024 (CN) 202410026897.9

(51) Int. Cl. G01N 27/623; H01J 49/00

(52) U.S. Cl. CPC G01N 27/623; H01J 49/004

(57) ABSTRACT

The present disclosure relates to the field of ion mobility analysis, and specifically provides a tandem U-shaped ion mobility spectrometer and an ion mobility analysis method. The tandem U-shaped ion mobility spectrometer includes two U-shaped ion mobility analyzers coupled in series. A first U-shaped ion mobility analyzer operates in a filter mode, and a second ion inlet of a second U-shaped ion mobility analyzer is disposed corresponding to a first ion outlet. An ion dissociation device is configured to receive and dissociate ions from the first U-shaped ion mobility analyzer and release fragment ions generated by the dissociation to the second U-shaped ion mobility analyzer. The tandem U-shaped ion mobility spectrometer reduces a complexity and a precision requirement of applying an electric field, has a high resolution and a dynamic range, and is suitable for studies of complex topics such as biomics.

### TECHNICAL FIELD

The present disclosure relates to the field of ion mobility analysis, particularly relates to a tandem U-shaped ion mobility spectrometer and an ion mobility analysis method.

### BACKGROUND ART

Ion mobility spectrometry is a technique for separating ions according to ion mobility. Since the ion mobility spectrometry can usually distinguish isomers which cannot be distinguished by mass spectrometry, an ion mobility spectrometer is widely used in the field of biological analysis.

In recent years, in order to increase dimension of parameters based on analysis, many attempts have been made to connect the ion mobility spectrometer in series with other devices. It is common to couple an ion mobility spectrometer and a mass spectrometer into a tandem mass spectrometry device, and further separate different ions by using different ion mobility properties, thereby improving ion identification capability. For example, U.S. Pat. No. 9,891,194 combines TIMS technique and DIA/DDA technique to form a parallel acquisition serial dissociation scheme (PASEF).

In some other studies, in order to improve separation efficiency (resolution capability) of the ion mobility of the ion mobility spectrometer for ions, it is proposed to couple two ion mobility spectrometers in series. U.S. Pat. No. 7,148,474B2 discloses different physical mechanisms based on IMS and FAIMS to couple FAIMS and IMS devices to achieve greater separation efficiency (resolution capability).

U.S. Pat. No. 7,855,360B2 discloses a method and a device for accurately identifying gas phase ions using multiple tandem filtering devices, and discloses increasing specificity and sensitivity of IMS detection based on tandem combination of two DMAs. One of the DMAs is operated at least under a high electric field within a nonlinear mobility range, but due to limitation of a filter mode of the DMAs, in one scanning cycle, only ions within a target mobility range can be selected, and other ions are completely lost, so that utilization efficiency of the ions of the DMAs is low, and an overall duty ratio of the system is low. Moreover, DMA is selected based on differential ion mobility, which is not conducive to structural characterization of molecules, and lacks a theoretical database for reference for complex topics such as biomics studies.

For ion mobility analysis of trace substances in some complex mixtures, U.S. Pat. No. 10,794,861B2 also discloses a method for analyzing ions and a tandem ion mobility spectrometer suitable for the method for analyzing ions, the tandem ion mobility spectrometer includes two tandem TIMS (trapped ion mobility spectrometer) analyzers, and an ion gate and a fragmentation unit disposed between the two tandem TIMS analyses. According to the above ion mobility spectrometer connected in series with the TIMS, the ion mobility can be pre-separated firstly, then the ions within the target mobility range are specifically fragmented, and then the generated fragment ions are subjected to ion mobility analysis. A resolution of the TIMS is high, and ions can be accumulated in a first TIMS, thereby improving a duty ratio of the tandem ion mobility spectrometer.

However, the tandem ion mobility spectrometer in the prior art still has the following problems.

In a first aspect, for omics studies of complex samples, contents of different components differ greatly, and an extremely high dynamic range is required to achieve better qualitative and quantitative results. In a parallel accumulation technique, in order to achieve ion utilization efficiency of 100%, ions need to be accumulated in the first TIMS, and the TIMS is developed based on a principle of an ion trap, a steric effect will cause extrusion of some low-abundance ions, and a dynamic range of a combined instrument will be limited by an ion capacity of the first TIMS.

In a second aspect, actions of the two TIMS need to be synchronized with each other, and a complexity and a control precision requirement of applying an electric field are high.

### SUMMARY OF THE INVENTION

In view of the above problems, the present disclosure provides a tandem U-shaped ion mobility spectrometer and an ion mobility analysis method, which reduce a complexity and a precision requirement of applying an electric field, have a high resolution and a dynamic range, and are suitable for studies of complex topics such as biomics.

Previously, the inventor of the present invention developed a U-shaped ion mobility analyzer (UMA, CN113495112A) operating in a filter mode, and an operating principle thereof is also based on a combined effect of gas flow and electric field on ions. During a specified time period, ions within a target mobility range are picked out and continuously released to a lower-stage device, and ions outside the target mobility range are blocked or filtered out only through balance of a gas flow pushing force and an electric field force. Different from a pulse release screening mode such as TIMS, the UMA operating in the filter mode can achieve continuous screening and continuous release of ions, so that the ions within the target mobility range can always move on a specified path without being bound or stored.

Specifically, a first aspect of the present disclosure provides a tandem U-shaped ion mobility spectrometer, including two U-shaped ion mobility analyzers coupled in series. Specifically, the tandem U-shaped ion mobility spectrometer in the present application includes a first U-shaped ion mobility analyzer, a second U-shaped ion mobility analyzer, a gas flow supply unit, a power supply and an ion dissociation device.

The first U-shaped ion mobility analyzer operates in a filter mode and includes a first channel and a second channel, the first channel being provided with a first ion inlet, and the second channel being provided with a first ion outlet; the second U-shaped ion mobility analyzer includes a third channel and a fourth channel, the third channel being provided with a second ion inlet, the fourth channel being provided with a second ion outlet, and the second ion inlet being disposed corresponding to the first ion outlet.

The gas flow supply unit supplies gas flow to the first channel and the second channel of the first U-shaped ion mobility analyzer and the third channel and the fourth channel of the second U-shaped ion mobility analyzer.

The power supply is electrically connected to the first U-shaped ion mobility analyzer and the second U-shaped ion mobility analyzer and is configured to apply an electric field force to ions in the first channel, the second channel, the third channel, and the fourth channel, the electric field force having a direction opposite to a direction of a force of the gas flow acting on the ions.

The ion dissociation device is configured to receive and dissociate ions from the first U-shaped ion mobility analyzer and release fragment ions generated by the dissociation to the second U-shaped ion mobility analyzer.

According to the tandem U-shaped ion mobility spectrometer of the present disclosure, the first U-shaped ion mobility analyzer operates in the filter mode and does not have a specific operating period, the second U-shaped ion mobility analyzer can freely set an electric field application mode or a control process, the operating period of the first U-shaped ion mobility analyzer does not need to be strictly matched, and characteristics of flexible control and high achievable duty ratio of the second U-shaped ion mobility analyzer are effectively utilized, so that rich functions of a MRM mode in tandem mass spectrometry analysis are achieved.

Moreover, since ions within the first target mobility range can keep moving on a specified path from the first ion inlet to the first ion outlet of the first U-shaped ion mobility analyzer with little or no stagnation or slowing of motion along the specified path, a concentration of high-abundance ions can be conveniently kept below a saturation limit of a detector, and low-abundance ions can be stably transmitted to a lower-stage device, so that quantitative accuracy of the high-abundance ions and detection sensitivity of the low-abundance ions are effectively improved, and a dynamic range of detection is improved. Moreover, the UMA operating in the filter mode can freely select a filtering channel, not only can scan step by step but also can skip-scan, which not only improves a scanning rate but also avoids interference of unnecessary ions.

In an optional technical solution of the present disclosure, the first channel, the second channel, the third channel and the fourth channel are disposed side by side in parallel to each other, and a path of the gas flow generated by the gas flow supply unit includes four gas flow sub-paths along respectively the first channel, the second channel, the third channel and the fourth channel.

According to the optional tandem U-shaped ion mobility spectrometer of the present disclosure, in general, a single UMA includes four electrode arrays disposed in parallel, each two electrode arrays form a group, defined channels are ion channels, and an ion inlet and an ion outlet are provided in the electrode arrays.

Therefore, the first channel, the second channel, the third channel and the fourth channel are disposed side by side in parallel, that is, all eight electrode arrays of the first U-shaped ion mobility analyzer and the second U-shaped ion mobility analyzer are disposed in parallel, four parallel ion channels are defined, and by arranging four gas flow sub-paths, the gas flow can be independently supplied to the four channels.

In an optional technical solution of the present disclosure, a path of the gas flow generated by the gas flow supply unit includes a gas flow path passing through both the first U-shaped ion mobility analyzer and the second U-shaped ion mobility analyzer.

According to the optional tandem U-shaped ion mobility spectrometer of the present disclosure, one gas flow path generated by the gas flow supply unit simultaneously passes through both the first U-shaped ion mobility analyzer and the second U-shaped ion mobility analyzer, so that at least one gas flow path can be saved, an amount of gas flow supplied by the gas flow supply unit is reduced, and a cost and a volume of a pump are reduced.

In an optional technical solution of the present disclosure, the first U-shaped ion mobility analyzer includes a first ion through path from the first ion inlet to the first ion outlet, the second U-shaped ion mobility analyzer includes a second ion through path from the second ion inlet to the second ion outlet, and the first ion through path and the second ion through path are disposed correspondingly to form an ion through path, and the second channel and the third channel are respectively disposed on two sides of the ion through path, and are collinearly butted end-to-end along a length direction.

According to the optional tandem U-shaped ion mobility spectrometer of the present disclosure, the first ion through path of the first U-shaped ion mobility analyzer and the second ion through path of the second U-shaped ion mobility analyzer are disposed correspondingly, so that when ion mobility analysis is not needed, ions can be directly passed through the tandem U-shaped ion mobility spectrometer along the ion through path and discharged from the second ion outlet.

The second channel and the third channel are respectively disposed on two sides of the ion through path, and are collinearly butted end-to-end along a length direction, so that the second channel and the third channel can be communicated to form a long ion channel perpendicular to the ion through path, ions within the target mobility range can be directly released from an end of the second channel away from the first ion transfer port, and after dissociation by the ion dissociation device, fragment ions enter the second U-shaped ion mobility analyzer from an end corresponding to the third channel. The gas flow supply unit only needs to generate one gas flow path in a long channel formed by the second channel and the third channel, so that compared with independent generation of four gas flow paths, one gas flow path can be saved, and a structure of the tandem U-shaped ion mobility spectrometer can be more compact.

In an optional technical solution of the present disclosure, the tandem U-shaped ion mobility spectrometer further includes a housing including a first chamber, a second chamber and a gas flow guiding portion. The first chamber covers an outer surface of the first U-shaped ion mobility analyzer, and has one end provided with a gas flow inlet, and the other end in communication with the gas flow guiding portion, and a first through hole is provided in the first chamber at a position corresponding to the first ion outlet, and the second chamber covers an outer surface of the second U-shaped ion mobility analyzer, and has one end provided with a gas flow outlet, and the other end in communication with the gas flow guiding portion, and a second through hole is provided in the second chamber at a position corresponding to the second ion inlet.

According to the optional tandem U-shaped ion mobility spectrometer of the present disclosure, by covering and guiding the housing, two gas paths used when the gas flow supply unit supplies gas flow to the first channel and the second channel can be guided and communicated to the third channel and the fourth channel respectively, so that on the premise of ensuring independence of the first U-shaped ion mobility analyzer and the second U-shaped ion mobility analyzer on ion control, the parallel gas flow channels can be reduced to two channels, thereby reducing a required gas flow flow rate, reducing a volume of a pump, and facilitating miniaturization of the device.

In an optional technical solution of the present disclosure, the second U-shaped ion mobility analyzer operates in a filter mode.

According to the optional tandem U-shaped ion mobility spectrometer of the present disclosure, the fragment ions within the second target mobility range may continuously move toward the second ion outlet in the second U-shaped ion mobility analyzer, and may be continuously released to the lower stage from the second ion outlet.

In an optional technical solution of the present disclosure, the power supply is configured to:

apply a first direct current electric field to the first channel, and apply a second direct current electric field to the second channel, where the first direct current electric field and the second direct current electric field are unchanged in one detection cycle; and apply a third direct current electric field to the third channel, and apply a fourth direct current electric field to the fourth channel, where, in one detection cycle, field strengths of the third direct current electric field and the fourth direct current electric field are synchronously increased, and a field strength difference between the third direct current electric field and the fourth direct current electric field is unchanged.

According to the optional tandem U-shaped ion mobility spectrometer of the present disclosure, the first U-shaped ion mobility analyzer is set to be in a filter-selected ion monitoring (filter-SIM) mode, that is, only ions within a fixed first target mobility range are allowed to pass through for a long time, and the second U-shaped ion mobility analyzer is set to be in a filter-scan mode, so that ions within different mobility ranges can be allowed to pass through once within different time, and selective scanning or full scanning within an ion mobility range can be performed on fragment ions.

In the above method, the first U-shaped ion mobility analyzer can continuously release ions within the fixed first target mobility range to the downstream, so that the second U-shaped ion mobility analyzer can receive fragment ions obtained by dissociating ions released from the first ion outlet of the first U-shaped ion mobility analyzer at any moment in the detection cycle, and the first U-shaped ion mobility analyzer and the second U-shaped ion mobility analyzer do not need to be synchronously set. In addition, the fragment ions are analyzed by the filter-scan mode, so that ions filtered out at a certain moment in one detection cycle are not lost in a scanning process, are stored in an ion storage region of the second U-shaped ion mobility analyzer, and can be released along with the scanning process at other moments, thereby improving utilization efficiency of ions and making a duty ratio of the tandem U-shaped ion mobility spectrometer higher, which can theoretically reach 100% duty ratio.

In an optional technical solution of the present disclosure, the power supply is configured to:

apply the first direct current electric field to the first channel, and apply the second direct current electric field to the second channel, where the first direct current electric field and the second direct current electric field are unchanged in one detection cycle; and apply the third direct current electric field to the third channel, and apply the fourth direct current electric field to the fourth channel, where the third direct current electric field and the fourth direct current electric field are unchanged in one detection cycle.

According to the optional tandem U-shaped ion mobility spectrometer of the present disclosure, both the first U-shaped ion mobility analyzer and the second U-shaped ion mobility analyzer operate in a filter-selected ion monitoring (filter-SIM) mode, so that fragment ions in the second target mobility range generated after ion dissociation in the first target mobility range can be continuously obtained, and the tandem U-shaped ion mobility spectrometer as a whole is static ion mobility analysis, which facilitates repeated analysis of a rear stage device, and does not need to synchronously set the rear stage device and the tandem U-shaped ion mobility spectrometer, which is more convenient to cooperate with the rear stage device for use.

In an optional technical solution of the present disclosure, the ion dissociation device dissociates ions in a target region, and the target region is disposed between the first ion outlet and the second ion inlet.

According to the optional tandem U-shaped ion mobility spectrometer of the present disclosure, the ion dissociation device is disposed between the first ion outlet and the second ion inlet, which can avoid impeding movement of ions and fragment ions within a target mobility range on a specified path.

In an optional technical solution of the present disclosure, the ion dissociation device is one or more of a collision-induced dissociation device, an electron dissociation device, a free radical dissociation device, and a migratory dissociation device.

A second aspect of the present disclosure discloses a U-shaped ion mobility analyzer, including a first channel, a second channel, a gas flow supply unit, a power supply, and an ion dissociation device. The first channel includes a first electrode array and a second electrode array which face each other in parallel; the second channel includes a third electrode array and a fourth electrode array which face each other in parallel, the first electrode array, the second electrode array, the third electrode array and the fourth electrode array being sequentially arranged side by side in parallel, the first electrode array including an ion inlet, the fourth electrode array including an ion outlet, the second electrode array and the third electrode array each including an ion through port and an ion transfer port, the ion through port, the ion inlet, and the ion outlet being correspondingly disposed, and the ion transfer port and the ion through port being arranged in a staggered manner; the gas flow supply unit supplies gas flow to the first channel and the second channel; the power supply is electrically connected to the first electrode array, the second electrode array, the third electrode array, and the fourth electrode array and configured to apply an electric field force to ions in the first channel and the second channel, the electric field force having a direction opposite to a direction of a force of the gas flow acting on the ions; and the ion dissociation device is disposed between the two ion through ports.

In a detection cycle, the power supply is configured to apply an electric field such that: in a first time period, the U-shaped ion mobility analyzer is configured in a filter mode, and stores target ions obtained by the filtering in the second channel, in a second time period after the first time period, the target ions stored in the second channel is dissociated by the ion dissociation device to obtain fragment ions, and the fragment ions are transferred back to the first channel, and in a third time period after the second time period, ion mobility analysis is performed on the fragment ions by causing the fragment ions to pass through a specified path sequentially from the first channel, the ion transfer port, the second channel, to the ion outlet.

In the above method, a single U-shaped ion mobility analyzer can be used to implement two-stage or multi-stage IMS/IMS tandem analysis, thereby further reducing a device volume and requirements for the gas flow flow rate.

A third aspect of the present disclosure discloses an ion mobility analysis method, including:
an ion filtering step of filtering, by a first U-shaped ion mobility analyzer configured in a filter mode, target ions having ion mobility within a target mobility range from an ion beam;
an ion dissociation step of receiving and dissociating the target ions filtered by the first U-shaped ion mobility analyzer to obtain fragment ions corresponding to the target ions; and
a fragment ion analysis step of performing ion mobility analysis on the fragment ions.

In an optional technical solution of the present disclosure, the fragment ion analysis step is performed by the second U-shaped ion mobility analyzer.

In an optional technical solution of the present disclosure, the first U-shaped ion mobility analyzer is configured in a filter-selected ion monitoring mode, and the second U-shaped ion mobility analyzer is configured in a filter-scan mode.

In an optional technical solution of the present disclosure, both the first U-shaped ion mobility analyzer and the second U-shaped ion mobility analyzer are configured in a filter-selected ion monitoring mode.

In an optional technical solution of the present disclosure, the fragment ion analysis step is performed by the first U-shaped ion mobility analyzer, and an ion dissociation device performing the ion dissociation step is disposed between two ion through ports of the first U-shaped ion mobility analyzer, in the ion filtering step, the target ions are stored in a second channel of the first U-shaped ion mobility analyzer, in the ion dissociation step, the target ions stored in the second channel are dissociated to obtain the fragment ions when passing through the ion through ports, and the fragment ions are transferred back to a first channel of the first U-shaped ion mobility analyzer, and in the fragment ion analysis step, the ion mobility analysis is performed on the fragment ions by causing the fragment ions to pass through a specified path sequentially from the first channel to the second channel.

### DESCRIPTIONS OF THE DRAWINGS

FIG. 1 is a perspective view of a structure of a single U-shaped ion mobility analyzer.

FIG. 2 is a side view of a structure of a single U-shaped ion mobility analyzer.

FIG. 3 is a schematic structural diagram of a tandem U-shaped ion mobility spectrometer according to Embodiment 1 of the present disclosure.

FIG. 4 is a schematic structural diagram of a tandem U-shaped ion mobility spectrometer according to Embodiment 2 of the present disclosure.

FIG. 5 is a schematic structural diagram of a tandem U-shaped ion mobility spectrometer according to Embodiment 3 of the present disclosure.

FIG. 6 is a schematic structural diagram of a tandem U-shaped ion mobility spectrometer according to Embodiment 4 of the present disclosure.

FIG. 7 is a schematic structural diagram of a tandem U-shaped ion mobility spectrometer according to Embodiment 5 of the present disclosure.

FIG. 8 is a flow chart of an ion mobility analysis method according to an embodiment of the present disclosure.

FIG. 9 is a schematic diagram of a process of implementing the ion mobility analysis method according to an embodiment of the present disclosure by using a U-shaped ion mobility analyzer which is a traditional hardware structure, in combination with an additional ion dissociation device and a specific electric field application method.

### LIST OF REFERENCE NUMERALS

U-shaped ion mobility analyzer 100, first electrode array 11, second electrode array 12, third electrode array 13, fourth electrode array 14, electrode array 15, acceleration electrode 19, backflow transition section 20, backflow port 21, ion diversion port 22, gas flow supply unit 2, power supply 3, first U-shaped ion mobility analyzer 4, first ion inlet 41, first ion transfer port 42, first ion outlet 43, second U-shaped ion mobility analyzer 5, second ion inlet 51, second ion transfer port 52, second ion outlet 53, first ion storage region 55, second ion storage region 56, ion dissociation device 6, housing 7, first chamber 71, second chamber 72, gas flow guiding portion 73, specified path 8, ion through path 9, first ion through path 91, second ion through path 92, ion through port 93, first channel CH1, second channel CH2, third channel CH3, fourth channel CH4, fifth channel CH5, and sixth channel CH6.

### DETAILED DESCRIPTION

The technical solutions in the embodiments of the present disclosure will be clearly and completely described below with reference to the accompanying drawings in the embodiments of the present disclosure, and obviously, the described embodiments are only a part of the embodiments of the present disclosure, and are not all embodiments. Based on the embodiments of the present disclosure, all other embodiments obtained by those skilled in the art without creative efforts shall fall within the scope of the present disclosure.

### Terms and Interpretation

A “filter mode” is an operating mode that can be applied to an ion mobility analyzer, which is similar to a filter mode of a general quadrupole mass filter. In the ion mobility analyzer, a characteristic of this operating mode is that only ions within a specific mobility range are allowed to pass through the ion mobility analyzer within a certain time period, while ions outside the mobility range are not allowed to pass through the ion mobility analyzer.

In the filter mode, ions continuously pass through the ion mobility analyzer, and during a process of passing through the ion mobility analyzer, target ions do not accumulate or store inside the ion mobility analyzer, and remain continuously moving along a specified path.

In an embodiment of the present disclosure, a physical quantity analyzed or measured by the ion mobility analyzer is defined as an ion mobility at low fields, the ion mobility is directly related to a collision cross-section (CCS) of the ions, that is, the ion mobility analyzer can be used to obtain CCS information. The ion mobility analyzer operating in the “filter mode” continuously screens out ions in a specific mobility range while an ion inlet keeps continuous sample injection.

A “filter mode” of a U-shaped ion mobility analyzer includes at least the following two types: one type is a static mode, that is, only ions within a certain target mobility range are allowed to pass through for a long time, which is usually referred to as a filter-selected ion monitoring (filter-SIM) mode; and the other type is a dynamic scanning mode, that is, an upper limit value (a second threshold value) and a lower limit value (a first threshold value) within a target mobility range corresponding to target ions are synchronously increased or decreased at different times, and the target ions within different mobility ranges sequentially pass through, which is referred to as a filter-scan mode.

It should be noted that a term “dissociation” also includes activation and unfolding for protein analysis. The activation includes changing ion energy of the protein, or removing salt clusters, water clusters and the like on a surface of the protein (called desolvation or declustering). The defolding is to change morphology of protein molecules to obtain more structural information. A means for achieving these two functions is similar to collision induced dissociation, which usually only requires applying a strong direct current electric field to cause the protein molecules to collide with a background gas.

### U-Shaped Ion Mobility Analyzer

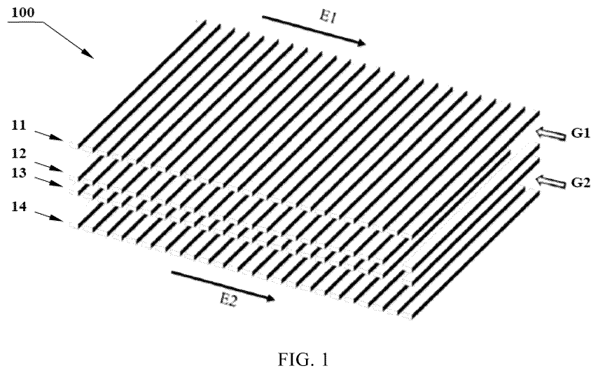

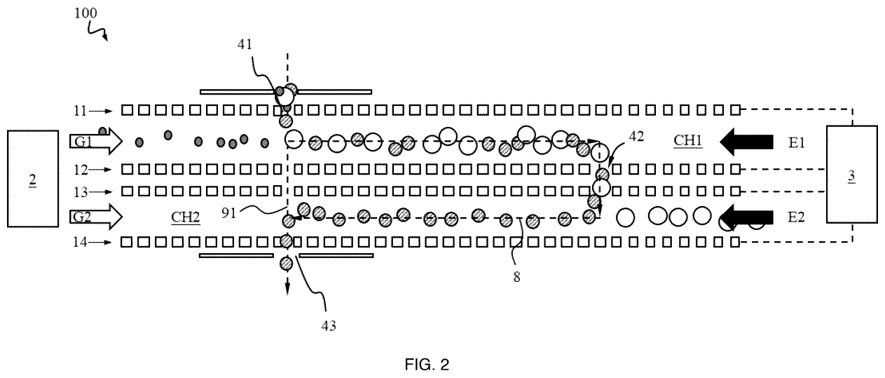

A hardware structure of a single U-shaped ion mobility analyzer 100 is shown in FIGS. 1 and 2. As shown in FIG. 1, the single U-shaped ion mobility analyzer 100 includes four electrode arrays (a first electrode array 11, a second electrode array 12, a third electrode array 13, and a fourth electrode array 14), electrodes in each electrode array are arranged in a same plane, planes of the four electrode arrays are parallel to each other, and gas flow G1 and G2 are blown toward between the first electrode array 11 and the second electrode array 12 and toward between the third electrode array 13 and the fourth electrode array 14 along a direction parallel to the electrode arrays. The first electrode array 11 and the second electrode array 12, and the third electrode array 13 and the fourth electrode array 14 are respectively applied with direct current electric fields E1 and E2 having a direction opposite to a direction of a force of the gas flow G1 and G2 acting on ions. For convenience of illustration, the structure of the U-shaped ion mobility analyzer 100 and a motion trajectory of ions in the U-shaped ion mobility analyzer 100 are shown in a side view in the figure following FIG. 1.

FIG. 2 is a side view structure of the single U-shaped ion mobility analyzer 100. As shown in FIG. 2, two parallel rows of the first electrode array 11 and the second electrode array 12 form a first channel CH1, two parallel rows of the third electrode array 13 and the fourth electrode array 14 form a second channel CH2, and each electrode array includes a plurality of linearly arranged electrodes. The first channel CH1 has a first ion inlet 41, and the first ion inlet 41 is provided on the first electrode array 11 close to a front stage side of the first channel CH1. A first ion transfer port 42 is correspondingly provided on the second electrode array 12 close to a rear stage side of the first channel CH1 and the third electrode array 13 close to a front stage side of the second channel CH2. A first ion outlet 43 is provided on the fourth electrode array 14 close to a rear stage side of the second channel CH2. The first ion inlet 41 corresponds to the first ion outlet 43 and is disposed with the first ion transfer port 42 in a staggered manner. Specifically, the first ion inlet 41 is located near the left end of the first electrode array 11, the first ion transfer port 42 is located near the right end of the second electrode array 12 and the third electrode array 13, and the first ion outlet 43 is located near the left end of the fourth electrode array 14.

The gas flow supply unit 2 supplies the gas flow G1 and G2 to the first channel CH1 and the second channel CH2 respectively. A direction of the gas flow is along a length direction of the first channel CH1 and the second channel CH2 in FIG. 2. The power supply 3 is electrically connected to each electrode of each electrode array, and is configured to apply an electric field force to ions in the first channel CH1 and the second channel CH2, the electric field force having a direction opposite to a direction of a force of the gas flow acting on the ions, and field strength distribution of electric fields in the first channel CH1 and the second channel CH2 can be adjusted by controlling the power supply 3, so as to control balance between a gas flow pushing force and the electric field force in the first channel CH1 and the second channel CH2.

Between the first channel CH1 and the second channel CH2, ions in the first channel CH1 may be transmitted or transferred from the first ion transfer port 42 to the second channel CH2 through a “dipole direct current” electric field or a deflected direct current electric field, thereby forming a U-shaped ion movement path sequentially passing through the first ion inlet 41, the first ion transfer port 42 and the first ion outlet 43, that is, a specified path 8 of ion movement in the U-shaped ion mobility analyzer 100.

Specifically, in the first channel CH1, the linear or non-linear first direct current electric field E1 may be applied to the electrode arrays 11 and 12, and an arrow at E1 in FIG. 2 indicates a direction in which the first direct current electric field acts on ions, and a direction of a force of the gas flow G1 flowing through the first channel CH1 and acting on the ions is opposite to a direction of an electric field force of the first direct current electric field E1 acting on the ions.

In the second channel CH2, the linear or non-linear second direct current electric field E2 is applied to the electrode arrays 13 and 14, and a direction of a force of the gas flow G2 flowing through the second channel CH2 and acting on the ions is opposite to a direction of an electric field force of the second direct current electric field E2 acting on the ions. Meanwhile, the gas flow G2 is in the same direction as the gas flow G1 in the first channel CH1, so as to provide the gas flow G1 and the gas flow G2 by using the single gas flow supply unit 2.

The filter mode of the U-shaped ion mobility analyzer 100 includes the following two types:

### (1) Filter-SIM Mode

The power supply 3 is configured to keep the first direct current electric field E1 of the first channel CH1 and the second direct current electric field E2 of the second channel CH2 unchanged, keep a fixed difference ΔE between E1 and E2, and continuously screen out ions within a fixed mobility range or having a fixed mobility (ΔE=0) through the balance of the gas flow pushing force and the electric field force in the first channel CH1 and the second channel CH2.

By setting fixed E1 and E2, and keeping E1 and E2 fixed difference ΔE,
a. the first channel CH1 may release ions having an ion mobility greater than a first threshold value to the second channel CH2, and the second channel CH2 may release ions having an ion mobility less than a second threshold value (greater than the first threshold value) to a lower-stage device. Ions having ion mobility less than the first threshold value will exit from the right end of the first channel CH1 and be eliminated, and ions having ion mobility greater than the second threshold value will exit from the left end of the second channel CH2 and be eliminated. Alternatively,
b. the first channel CH1 may release ions having an ion mobility less than the second threshold value to the second channel CH2, and the second channel CH2 may release ions having an ion mobility greater than the first threshold value (less than the second threshold value) to the lower-stage device. Ions having ion mobility greater than the second threshold value will exit from the left end of the first channel CH1 and be eliminated, and ions having ion mobility less than the first threshold value will exit from the right end of the second channel CH2 and be eliminated. (Case shown in FIG. 2)

Ions within a target mobility range between the first threshold value and the second threshold value are target ions.

### (2) Filter-Scan Mode

The power supply 3 is configured to keep the difference ΔE between the first direct current electric field E1 of the first channel CH1 and the second direct current electric field E2 of the second channel CH2 unchanged, and synchronously change E1 and E2, for example, scan the E1 and E2 from low to high, so as to scan different mobility ranges or mobility values (ΔE=0) in a fixed mobility window, for example, allow ions to pass through in order from high mobility to low mobility. In other words, a difference from the filter-SIM mode is that in the filter-scan mode, E1 and E2 change with time, and correspondingly, a first threshold value and a second threshold value corresponding to E1 and E2 also change with time, thereby changing a target mobility range corresponding to the target ions.

The U-shaped ion mobility analyzer 100 operating in the filter mode can screen out ions meeting the target mobility range and continuously moving along the specified path 8 and make ions not meeting the target mobility range leave the specified path 8 by only using the balance between the gas flow pushing force (magnitude depends on CCS, gas flow flow rate, etc.) and the electric field force, and filter out and lose the ions from two ends of the first channel CH1 or the second channel CH2, or transmit the ions to the ends of the first channel CH1 or the second channel CH2 for storage, thereby screening out ions within the target mobility range and continuously releasing the ions from the first ion outlet 43. For specific ion moving, storing and filtering processes, refer to patent CN113495112A, and details will not be repeated here.

### Tandem U-Shaped Ion Mobility Spectrometer

### Embodiment 1

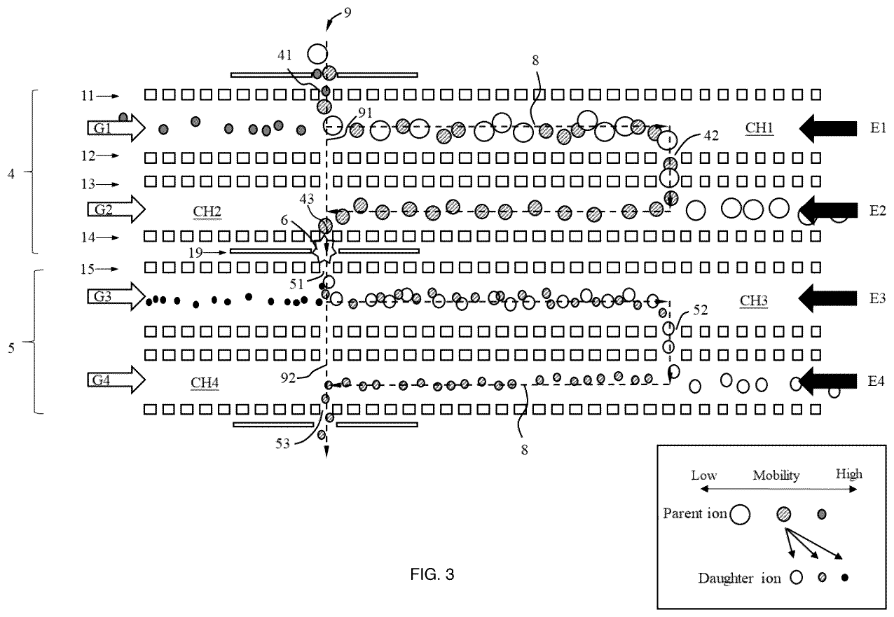

FIG. 3 is a schematic structural diagram of a tandem U-shaped ion mobility spectrometer according to the embodiment. As shown in FIG. 3, the tandem U-shaped ion mobility spectrometer in the embodiment is composed of two U-shaped ion mobility analyzers 100 connected in series (that is, ions flowing out of a first U-shaped ion mobility analyzer 4 flow into a second U-shaped ion mobility analyzer 5). Both the first U-shaped ion mobility analyzer 4 and the second U-shaped ion mobility analyzer 5 may adopt substantially the same hardware structure as the U-shaped ion mobility analyzer 100 described above, which will not be repeated here.

In the tandem U-shaped ion mobility spectrometer in the embodiment, the first ion outlet 43 of the first U-shaped ion mobility analyzer 4 is disposed corresponding to a second ion inlet 51 of the second U-shaped ion mobility analyzer 5, and ions released from the first ion outlet 43 of the first U-shaped ion mobility analyzer 4 may enter the second U-shaped ion mobility analyzer 5 through the second ion inlet 51.

The first U-shaped ion mobility analyzer 4 further includes a first ion through path 91 through from the first ion inlet 41 to the first ion outlet 43, the second U-shaped ion mobility analyzer 5 includes a second ion through path 92 through from the second ion inlet 51 to the second ion outlet 53, and the first ion through path 91 and the second ion through path 92 are correspondingly disposed to form an ion through path 9. The ion through path 9 may be used as a standby path other than the specified path 8, and when ion mobility analysis is not required, ions pass through the ion through path 9, pass through the tandem U-shaped ion mobility spectrometer from the first ion inlet 41, and flow out of the second ion outlet 53.

An ion source may be disposed in a front stage of the first channel CH1, and ions generated by the ion source enter the first channel CH1 through the first ion inlet 41. A rear stage of the fourth channel CH4 may be provided with other detection instruments, fragment ions released from the second ion outlet 53 may enter a rear stage detection instrument for further detection, and the rear stage detection instrument may be, for example, a mass spectrometry analysis device, especially an MS/MS tandem mass spectrometry analysis device, especially high-resolution tandem mass spectrometry analysis devices such as a Q-TOF, and is suitable for omics analysis of proteins, polypeptides and the like.

In some optional embodiments, the ion source includes at least one ion source selected from the group consisting of: (i) an electrospray ionization (“ESI”) ion source; (ii) an atmospheric pressure photoionization (“APPI”) ion source; (iii) an atmospheric pressure chemical ionization (“APCI”) ion source; (iv) a matrix-assisted laser desorption ionization (“MALDI”) ion source; (v) a laser desorption ionization (“LDI”) ion source; (vi) an atmospheric pressure ionization (“API”) ion source; (vii) an on-silicon desorption ionization (“DIOS”) ion source; (viii) an electron impact (“EI”) ion source; (ix) a chemical ionization (“CI”) ion source; (x) a field ionization (“FI”) ion source; (xi) a field desorption (“FD”) ion source; (xii) an inductively coupled plasma (“ICP”) ion source; (xiii) a fast atom bombardment (“FAB”) ion source; (xiv) a liquid secondary ion mass spectrometry (“LSIMS”) ion source; (xv) an electrospray desorption ionization (“DESI”) ion source; (xvi) a nickel-63 radioactive ion source; (xvii) an atmospheric pressure matrix-assisted laser desorption ionization ion source; (xviii) a thermal spray ion source; (xix) an atmospheric sampling glow discharge ionization (“ASGDI”) ion source; (xx) a glow discharge (“GD”) ion source; (xxi) an impactor ion source; (xxii) a real-time direct analysis (“DART”) ion source; (xxiii) a laser spray ionization (“LSI”) ion source; (xxiv) an acoustic spray ionization (“SSI”) ion source; (xxv) a matrix-assisted inlet ionization (“MAII”) ion source; (xxvi) a solvent-assisted inlet ionization (“SAII”) ion source; (xxvii) a Penning ionization ion source; (xxviii) a laser ablation electrospray ionization (“LAESI”) ion source; and (xxix) He plasma (HePl) ion source. Preferably, a room pressure or real-time ion source such as the electrospray ionization (“ESI”) ion source, the matrix-assisted laser desorption ionization ion source (“MALDI”), the real-time direct analysis ion source (“DART”), or the laser ablation electrospray ionization (“LAESI”) ion source is employed.

The mass spectrometry analysis device may be one or more of a quadrupole mass analysis device, a time-of-flight mass spectrometer, a Fourier transform mass spectrometer, an ion trap mass spectrometer, and a magnetic mass spectrometer.

The tandem U-shaped ion mobility spectrometer according to the embodiment further includes an ion dissociation device 6 configured to receive and dissociate ions released from the first ion outlet 43, and release fragment ions generated by dissociation to the second ion inlet 51. In FIGS. 3 to 7 and FIG. 9, a mark position of the ion dissociation device 6 is a position of a target region targeted by the ion dissociation device 6.

The ion dissociation device 6 may be an ion dissociation device 6 additionally arranged on the basis of a tandem structure of the first U-shaped ion mobility analyzer 4 and the second U-shaped ion mobility analyzer 5, for example, additionally arranged collision-induced dissociation device, electron dissociation device, free radical dissociation device or migratory dissociation device. In some optional embodiments, a target region is further formed in a UMA analyzer 2, the ion dissociation device 6 dissociates ions in the target region, and the target region may be disposed at a plurality of reasonable positions on a rear stage side of the first ion outlet 43, for example, the target region may be disposed between the first ion outlet 43 and the second ion inlet 51. Referring to FIG. 3, in some optional embodiments, the ion dissociation device 6 may be an acceleration electrode 19 disposed between the first ion outlet 43 and the second ion inlet 51, and by using the acceleration electrode 19, ions may be rapidly accelerated in this region to collide with gas molecules, thereby dissociating the ions.

In other optional embodiments, the ion dissociation device 6 may further include one or more ion dissociation devices selected from the group consisting of: a collision induced dissociation (CID) device; a surface induced dissociation (SID) device; an electron transfer dissociation (ETD) device; an electron capture dissociation (ECD) device; an electron collision or impact dissociation device; a light induced dissociation (PID) device; a laser induced dissociation device; an infrared radiation induced dissociation device; an ultraviolet radiation induced dissociation device; a nozzle-separator interface dissociation device; an in-source dissociation device; an in-source collision-induced dissociation device; a thermal or temperature source dissociation device; an electric field induced dissociation device; a magnetic field induced dissociation device; an enzyme digestion or enzyme degradation dissociation device; an ion-ion reaction dissociation device; an ion-molecule reaction dissociation device; an ion-atom reaction dissociation device; an ion-metastable ion reaction dissociation device; an ion-metastable molecule reaction dissociation device; and an electron ionization dissociation (EID) device.

In the tandem U-shaped ion mobility spectrometer in the embodiment, the first U-shaped ion mobility analyzer 4 operates in the filter mode (filter-SIM or filter-scan), and an operating mode of the second U-shaped ion mobility analyzer 5 is not limited, and may operate in the filter mode or in other modes. For example, the second U-shaped ion mobility analyzer 5 may operate in a “trap-release” mode to achieve a higher duty ratio.

Optionally, the first U-shaped ion mobility analyzer 4 operates in the filter-SIM mode, and the filter-SIM mode is used as a static filter mode, and can continuously release ions within a fixed ion mobility window range from the first ion outlet 43, so that the lower stage ion dissociation device 6 and the second U-shaped ion mobility analyzer 5 do not need to be synchronously disposed with the first U-shaped ion mobility analyzer 4, and can receive ions within a first target ion mobility window range released by the first ion outlet 43 at any time.

Further, the second U-shaped ion mobility analyzer 5 may operate in the filter-SIM or the filter-scan mode, and when the second U-shaped ion mobility analyzer 5 operates in the filter-SIM mode, fragment ions in the second target mobility range generated after the ions in the first target mobility range are dissociated can be continuously obtained from the first ion outlet 43.

When the second U-shaped ion mobility analyzer 5 operates in the filter-scan mode, ions in different ion mobility ranges can be allowed to pass through sequentially at different moments, so that selective scanning analysis or full scanning analysis can be performed on the ion fragments. Further, ions filtered out in a certain time period may be stored in an ion storage region of the second U-shaped ion mobility analyzer 5, and may be released along with the scanning process in other time periods, thereby improving utilization efficiency of ions and improving the duty ratio of the tandem U-shaped ion mobility spectrometer.

In the above method, the two U-shaped ion mobility analyzers 100 may be coupled in series, ions enter the first U-shaped ion mobility analyzer 4 from the first ion inlet 41, the first U-shaped ion mobility analyzer 4 operating in the filter mode performs filtering and screening on the ion mobility of the ions only by using an effect of a reverse gas flow pushing force and an electric field force, ions not within the first target mobility range are filtered out of the specified path 8, the ions within the first target mobility range continuously move to the first ion outlet 43 along the specified path 8 and are continuously released, enter the ion dissociation device 6 for dissociation, fragment ions obtained by the dissociation enter the second U-shaped ion mobility analyzer 5 from the second ion inlet 51, and are released to the lower-stage device from the second ion outlet 53 after ion mobility analysis of the fragment ions in the second U-shaped ion mobility analyzer 5.

Since the tandem U-shaped ion mobility spectrometer in the embodiment needs to couple the first U-shaped ion mobility analyzer 4 and the second U-shaped ion mobility analyzer 5 in series, the gas flow supply unit 2 needs to simultaneously perform gas flow supply on the first U-shaped ion mobility analyzer 4 and the second U-shaped ion mobility analyzer 5.

In general, as shown in FIG. 3, based on a fact that a single U-shaped ion mobility analyzer has two ion channels, two gas flow paths are required, the first ion outlet 43 of the first U-shaped ion mobility analyzer 4 is provided on the electrode array 14, the second ion inlet 51 of the second U-shaped ion mobility analyzer 5 is provided on the electrode array 15, and when the first ion outlet 43 and the second ion inlet 51 are aligned, that is, the first U-shaped ion mobility analyzer 4 and the second U-shaped ion mobility analyzer 5 are arranged in parallel with each other, at this time, the first channel CH1, the second channel CH2, the third channel CH3 and the fourth channel CH4 are disposed side by side in parallel to each other.

Since the first channel CH1, the second channel CH2, the third channel CH3 and the fourth channel CH4 are disposed in parallel and independently, the gas flow supply unit 2 needs to supply gas flow to the first channel CH1, the second channel CH2, the third channel CH3 and the fourth channel CH4, respectively, and the formed gas flow path includes four gas flow sub-paths G1, G2, G3 and G4 along the first channel CH1, the second channel CH2, the third channel CH3 and the fourth channel CH4.

In other optional embodiments, considering that an amount of gas flow supplied by each channel is substantially the same, a gas flow supply amount increases with each additional gas flow sub-path, and the gas flow supply unit 2 correspondingly needs to select a vacuum pump with a larger pumping speed, which increases a volume of a vacuum system. In order to reduce the gas flow supply amount of the gas flow supply unit 2, some gas flow paths are merged in some embodiments of the present disclosure.

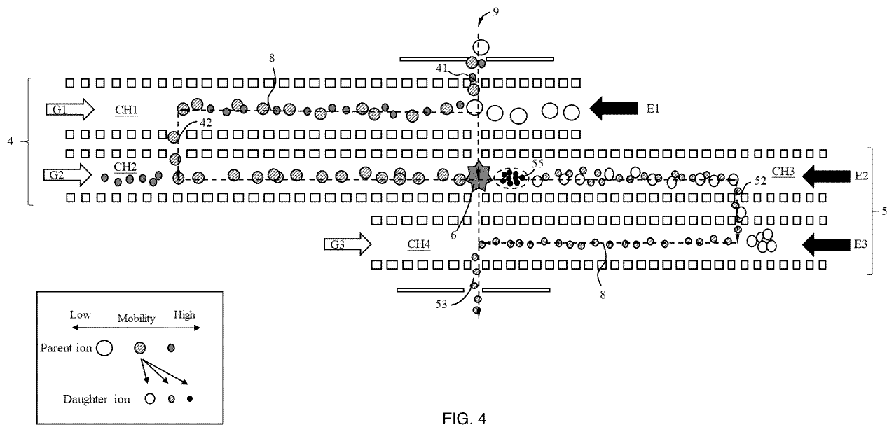

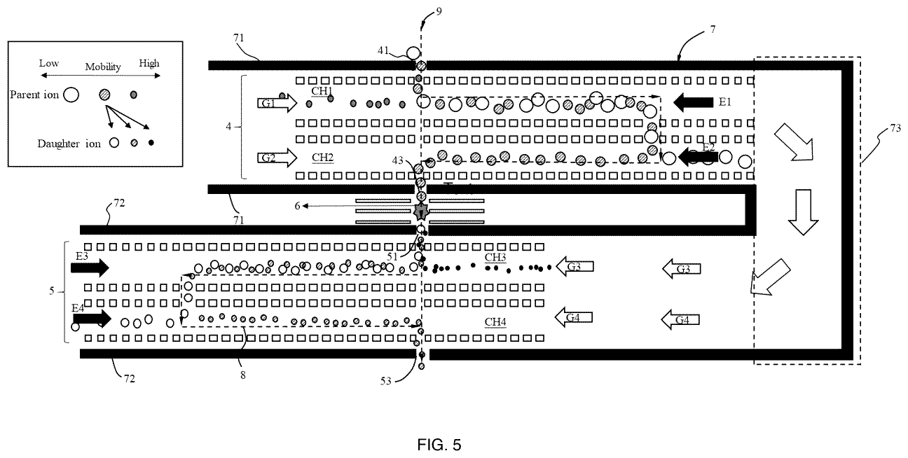

FIG. 4 and FIG. 5 show two more specific schematic structural diagrams of a tandem U-shaped ion mobility spectrometer with a common gas flow path.

### Embodiment 2

FIG. 4 is a tandem U-shaped ion mobility spectrometer with three rows of channels. As shown in FIG. 4, the second channel CH2 of the first U-shaped ion mobility analyzer 4 and the third channel CH3 of the second U-shaped ion mobility analyzer 5 are connected to each other. Specifically, the second channel CH2 and the third channel CH3 are respectively disposed on two sides of the ion through path 9 and collinearly butted end-to-end along a length direction, the second channel CH2 and the third channel CH3 are communicated to form a long ion channel perpendicular to the ion through path 9, and the ion dissociation device 6 is disposed between opposite ends of the second channel CH2 and the third channel CH3. In the above method, the ions may be directly released from an end of the second channel CH2 away from the first ion transfer port 42, dissociated by the ion dissociation device 6, and then enter the second U-shaped ion mobility analyzer 5 from an end corresponding to the third channel CH3. Only one gas flow path G2 is formed in the long ion channel formed by the second channel CH2 and the third channel CH3, so that the gas flow supply unit 2 only needs to generate three gas flow paths G1, G2 and G3, one gas flow path can be omitted, and a structure of the tandem U-shaped ion mobility spectrometer can be more compact.

As shown in FIG. 4, since ends of the second channel CH2 and the third channel CH3 are in direct communication with each other to form the specified path 8 for the target ions within the target mobility range and the fragment ions thereof to move, in order to prevent ions within the non-target mobility range in the third channel CH3 from entering the second channel CH2 reversely when being filtered out and improve the duty ratio of the system, a first ion storage region 55 may be disposed on an end portion of the third channel CH3 corresponding to the second channel CH2, and a radio frequency electric field may be applied to an electrode corresponding to the first ion storage region 55 when storing ions to bind the ions, and the stored ions are quickly transferred to the second U-shaped ion mobility analyzer 5 within a time period in which mobility needs to be analyzed for mobility analysis.

In the above method, the tandem U-shaped ion mobility spectrometer according to the embodiment can reduce the number of channels to three, and has the ion through path 9, which can quickly pass through sample ions when mobility analysis is not needed, thereby enriching use scenarios of a product.

### Embodiment 3

FIG. 5 is a tandem U-shaped ion mobility spectrometer with two rows of channels. As shown in FIG. 5, in the second optional tandem U-shaped ion mobility spectrometer with the common gas flow path, the first U-shaped ion mobility analyzer 4 and the second U-shaped ion mobility analyzer 5 are arranged parallel to each other, and the first ion outlet 43 and the second ion inlet 51 are disposed correspondingly.

Different from the tandem U-shaped ion mobility spectrometer in FIG. 3, the first U-shaped ion mobility analyzer 4 and the second U-shaped ion mobility analyzer 5 in the embodiment of FIG. 5 are further coated with a housing 7, and the housing 7 includes a first chamber 71, a second chamber 72 and a gas flow guiding portion 73. The first chamber 71 covers an outer surface of the first U-shaped ion mobility analyzer 4, the left end of the first chamber 71 is provided with a gas flow inlet, the right end of the first chamber 71 is in communication with the gas flow guiding portion 73, and a first through hole is provided in the first chamber 71 at a position corresponding to the first ion outlet 43, and the second chamber 72 covers an outer surface of the second U-shaped ion mobility analyzer 5, the left end of the second chamber 72 is provided with a gas flow outlet, the right end of the second chamber 72 is in communication with the gas flow guiding portion 73, and a second through hole is provided in the second chamber 72 at a position corresponding to the second ion inlet 51.

The gas flow supply unit 2 may supply the two gas flow G1 and G2 to the first channel CH1 and the second channel CH2 from the gas flow inlet of the first chamber 71. A gas flow path of the first gas flow G1 flows to the gas flow guiding portion 73 along the first channel CH1, a gas flow path of the second gas flow G2 flows to the gas flow guiding portion 73 along the second channel CH2, and the two gas flow G1 and G2 merge and then are bent by the gas flow guiding portion 73, and then reversely pass through the third channel CH3 and the fourth channel CH4 respectively, and finally flow out through the gas flow outlet.

Through a guiding effect of the gas flow guiding portion 73 on the gas flow, on the premise of ensuring independence of the first U-shaped ion mobility analyzer 4 and the second U-shaped ion mobility analyzer 5 on ion control, the parallel gas flow channels can be reduced to two channels, thereby reducing a required gas flow flow rate, reducing a volume of a vacuum pump, and facilitating miniaturization of the device. In addition, in the embodiment, the ions may directly pass through the tandem U-shaped ion mobility spectrometer from the ion through path 9, and flow out from the second ion outlet 53, thereby effectively improving universality of the tandem U-shaped ion mobility spectrometer for different use scenarios.

### Embodiment 4

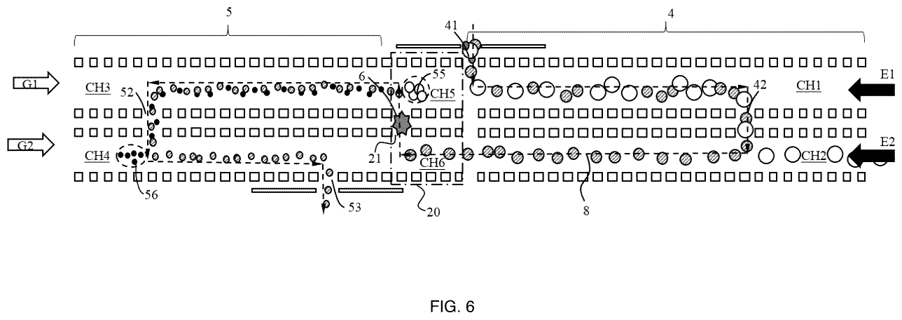

FIG. 6 provides another tandem U-shaped ion mobility spectrometer with two rows of channels. Referring to FIG. 6, the tandem U-shaped ion mobility spectrometer includes the first U-shaped ion mobility analyzer 4 and the second U-shaped ion mobility analyzer 5 that are co-linearly opposite to each other, and a backflow transition section 20 disposed between the first U-shaped ion mobility analyzer 4 and the second U-shaped ion mobility analyzer 5. The backflow transition section 20 includes a fifth channel CH5 and a sixth channel CH6, the first channel CH1, the fifth channel CH5, and the third channel CH3 are sequentially communicated end-to-end, and the second channel CH2, the sixth channel CH6, and the fourth channel CH4 are sequentially communicated end-to-end.

The backflow transition section 20 further includes a backflow port 21 communicating the fifth channel CH5 and the sixth channel CH6, and the ion dissociation device 6 is disposed in the backflow port 21. After target ions flowing out of the second channel CH2 enter the sixth channel CH6, the target ions are dissociated through the backflow port 21 to obtain fragment ions, and the fragment ions are transmitted to the fifth channel CH5. The fragment ions enter the fifth channel CH5 and then flow to the third channel CH3 of the second U-shaped ion mobility analyzer 5, and mobility analysis is completed by using the U-shaped specified path 8 of the second U-shaped ion mobility analyzer 5 sequentially passing through the third channel CH3, a second ion transfer port 52, the fourth channel CH4, and the second ion outlet 53.

The second U-shaped ion mobility analyzer 5 may operate in the filter mode, or may operate in any other reasonable mode such as a trap-release mode, which is not limited in the present application. In some embodiments, the fifth channel CH5 of the backflow transition section 20 has the first ion storage region 55, and an end of the fourth channel CH4 may be provided with a second ion storage region 56 to temporarily store some fragment ions outside a target mobility range, thereby improving a duty ratio of an instrument.

In some embodiments, the fifth channel CH5 may further be provided with an ion removal device (not shown) to remove ions that are filtered out by the first channel CH1 and/or the third channel CH3 and that are not within the target mobility range, so as to avoid influence on analysis of the third channel CH3. There are many methods to remove ions, such as removing a radio frequency voltage in the region, or applying a more negative direct current potential to attract positive ions to electrodes and annihilate the positive ions.

In the above method, the tandem U-shaped ion mobility spectrometer according to the embodiment can reduce the parallel gas flow channels into two rows, and gas flow is more uniform; moreover, in this tandem U-shaped ion mobility spectrometer, by configuring the second U-shaped ion mobility analyzer 5 in the filter mode, the ions can still be continuously transmitted to the lower stage through the tandem U-shaped ion mobility spectrometer, which avoids influence on detection of low-abundance ions due to a space charge effect caused by ion storage, and can effectively meet detection requirements of the low-abundance ions by omics studies such as protein and polypeptide.

### Embodiment 5

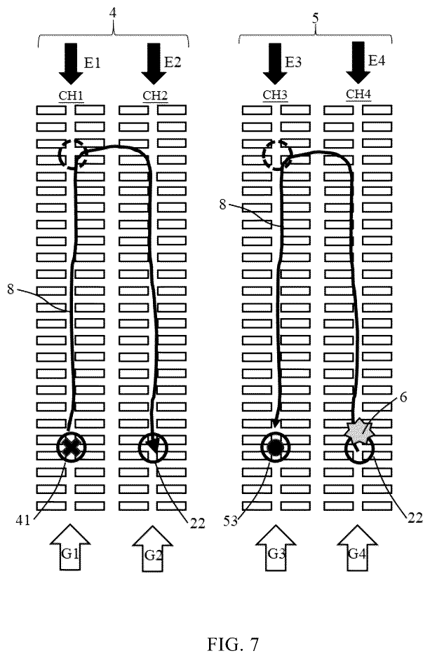

FIG. 7 provides a stereoscopic tandem U-shaped ion mobility spectrometer formed by stacking the first U-shaped ion mobility analyzer 4 and the second U-shaped ion mobility analyzer 5. Referring to FIG. 7, four groups of channels are distributed in a 2×2 layout, that is, the third channel CH3 and the fourth channel CH4 are respectively disposed on the same side of the first channel CH1 and the second channel CH2, an electrode array of the third channel CH3 and an electrode array of the first channel CH1 are arranged correspondingly, and an electrode array of the fourth channel CH4 and an electrode array of the second channel CH2 are arranged correspondingly.

In FIG. 7, for convenience of illustration, the third channel CH3 and the fourth channel CH4 actually located at a lower layer are shown in the same picture as the first channel CH1 and the second channel CH2 actually located at an upper layer.

Referring to FIG. 7, after ions enter the first channel CH1 from the first ion inlet 41 in a direction perpendicular to a paper surface, the ions pass through the U-shaped specified path 8 to an ion diversion port 22, and a moving direction changes from a direction along the paper surface to the direction perpendicular to the paper surface at the ion diversion port 22; after the ions reach the fourth channel CH4 of the lower layer, the ions are first dissociated at the ion dissociation device 6, and then mobility analysis is performed on the fragment ions by using the U-shaped specified path 8, and fragment ions meeting conditions are transmitted to a lower-stage device through the second ion outlet 53.

The tandem U-shaped mobility spectrometer according to the embodiment has a compact and regular structure, has a relatively small axial length, and has a relatively uniform gas flow field. In addition, positions of the first ion inlet 41 and the second ion outlet 53 correspond to each other, and when mobility analysis is not needed, the ions may also directly pass through the tandem U-shaped mobility spectrometer.

Hereinafter, an ion mobility analysis method applicable to the tandem U-shaped ion mobility spectrometer is described in detail based on the tandem U-shaped ion mobility spectrometer in the embodiments of the present disclosure with reference to the accompanying drawings.

### Ion Mobility Analysis Method

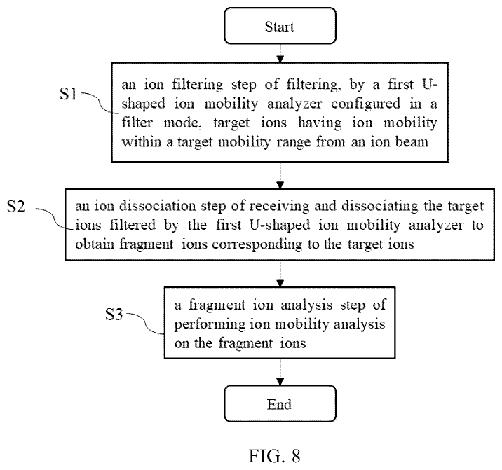

Some embodiments of the present disclosure further provide an ion mobility analysis method. FIG. 8 is a flowchart of the ion mobility analysis method including:
an ion filtering step S1 of filtering, by the first U-shaped ion mobility analyzer 4 configured in a filter mode, target ions having ion mobility within a target mobility range from an ion beam;
an ion dissociation step S2 of receiving and dissociating the target ions filtered by the first U-shaped ion mobility analyzer 4 to obtain fragment ions corresponding to the target ions; and
a fragment ion analysis step S3 of performing ion mobility analysis on the fragment ions.

The ion mobility analysis method not only can be applied to the tandem U-shaped ion mobility spectrometer according to Embodiments 1-5, but also can be applied to the U-shaped ion mobility analyzer 100 which is a traditional hardware structure, and is implemented by changing and controlling an electric field application method.

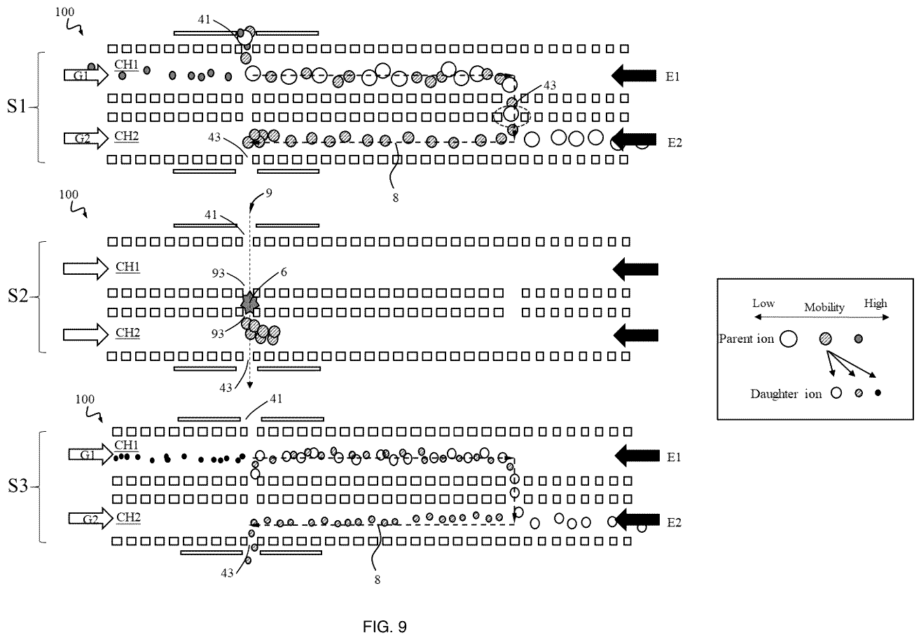

FIG. 9 is a schematic diagram of a process of implementing the ion mobility analysis method according to an embodiment of the present disclosure by using the U-shaped ion mobility analyzer 100 which is a traditional hardware structure, in combination with an additional ion dissociation device 6 and a specific electric field application method.

In the embodiment, the ions are periodically generated or transmitted to the first ion inlet 41 and enter the first channel CH1 of the U-shaped ion mobility analyzer 100 from the first ion inlet 41. In one detection cycle, referring to FIG. 9, different from a method in which target ions filtered out in the existing filter mode are directly transmitted to the lower-stage device, in the ion filtering step S1 corresponding to the first time period in this embodiment, the filtered target ions are gradually accumulated or stored at a position of the second channel CH2 close to the first ion outlet 43.

When a pulsed ion packet enters the U-shaped ion mobility analyzer 100 and is filtered, generation or transmission of ions may be turned off, and the ions stored at the position of the second channel CH2 close to the first ion outlet 43 are dissociated and analyzed. Specifically, the ion dissociation device 6 is disposed between two ion through ports 93 of the ion through path 9.

During a second time period after the first time period, the ions stored in the second channel CH2 close to the first ion outlet 43 will pass through the ion through port 93 and return to the first channel CH1 from the second channel CH2, and during the period, are ionized by the ion dissociation device 6 to obtain fragment ions.

During a third time period after the second time period, the fragment ions can be analyzed for ion mobility again via the U-shaped specified path 8, and the analyzed ions are transmitted to a lower stage.

In the above method, the ion mobility analysis method according to the embodiment may implement two-stage or multi-stage IMS/IMS tandem analysis by using the single U-shaped ion mobility analyzer 100, to further reduce a device volume and requirements for the gas flow flow rate.

The ion mobility analysis method according to the embodiment may also be applied to a tandem U-shaped ion mobility spectrometer having the first U-shaped ion mobility analyzer 4 and the second U-shaped ion mobility analyzer 5, for example, the tandem U-shaped ion mobility spectrometer according to Embodiments 1-5 of the present disclosure.

In some embodiments, the first U-shaped ion mobility analyzer 4 and the second U-shaped ion mobility analyzer 5 may both operate in the filter-selected ion monitoring (filter-SIM) mode.

Taking the tandem U-shaped ion mobility spectrometer in FIG. 3 as an example, firstly, the ion filtering step S1 is performed, that is, the power supply 3 applies the first direct current electric field E1 to the first channel CH1 of the first U-shaped ion mobility analyzer 4, applies the second direct current electric field E2 to the second channel CH2 of the first U-shaped ion mobility analyzer 4, and the first direct current electric field E1 and the second direct current electric field E2 remain unchanged in one detection cycle. Ions generated by an upper-stage ion source of the tandem U-shaped ion mobility spectrometer continuously enter the first U-shaped ion mobility analyzer 4 from the first ion inlet 41, under combined action of the first direct current electric field E1 and the gas flow G1 in the first channel CH1, ions having an ion mobility greater than the first target ion mobility range flow out of the end of the first channel CH1 and are filtered out, and the rest ions deflect under action of a deflection electric field at the first ion transfer port 42 and enter the second channel CH2 through the first ion transfer port 42, and under action of the second direct current electric field E2 and the gas flow G2 in the second channel CH2, ions having an ion mobility smaller than the first target ion mobility range flow out of the end of the second channel CH2 and are filtered out, so that ions in the fixed first target ion mobility range can continuously move on the specified path 8 from the first ion inlet 41 to the first ion outlet 43, and are continuously released from the first ion outlet 43 to the second U-shaped ion mobility analyzer 5.

Then, the ion dissociation step S2 is performed, that is, the ion dissociation device 6 receives the ions released by the first ion outlet 43, and dissociates the ions to generate fragment ions, and the obtained fragment ions are introduced into the second ion inlet 51 of the second U-shaped ion mobility analyzer 5; in FIG. 3, an electrode array 19 is disposed between the first ion outlet 43 and the second ion inlet 51 as the ion dissociation device 6, the ions released from the first ion outlet 43 may collide and dissociate with gas molecules under acceleration of the electrode array 19, and the dissociated fragment ions enter the second ion inlet 51.

Finally, the fragment ion analysis step S3 is performed, that is, the power supply 3 applies a third direct current electric field E3 to the third channel CH3 of the second U-shaped ion mobility analyzer 5, and applies a fourth direct current electric field E4 to the fourth channel CH4 of the second U-shaped ion mobility analyzer 5. In one detection cycle, the third direct current electric field E3 and the fourth direct current electric field E4 remain unchanged. The fragment ions dissociated by the ion dissociation device 6 continuously enter the second U-shaped ion mobility analyzer 5 from the second ion inlet 51, under action of the third direct current electric field E3 and gas flow G3 in the third channel CH3, fragment ions having an ion mobility greater than a second target ion mobility range flow out of the end of the third channel CH3 and are filtered out, and the rest fragment ions deflect under the action of the deflection electric field at the second ion transfer port 52 and enter the fourth channel CH4 through the second ion transfer port 52, and under action of the fourth direct current electric field E4 and gas flow G4 in the fourth channel CH4, the fragment ions having an ion mobility smaller than the target ion mobility range flow out of the end of the fourth channel CH4 and are filtered out, so that fragment ions in the fixed second target ion mobility range can continuously move on the specified path 8 from the second ion inlet 51 to the second ion outlet 53, and are continuously released from the second ion outlet 53 to the lower-stage device.

In the above method, the ions are subjected to two filtering processes without being subjected to a storage process, so that the target ions are always continuously transmitted to a rear-stage device, a problem of low-abundance ion resolution reduction caused by space charge effect is further solved, and meanwhile, mobility tandem analysis of specific parent ion-daughter ion pairs can be performed.

In some other embodiments, the first U-shaped ion mobility analyzer 4 may be configured in the filter-selected ion monitoring (filter-SIM) mode, and the second U-shaped ion mobility analyzer 5 may be configured in the filter-scan mode.

Specifically, referring to FIG. 4 and FIG. 7, firstly, the ion filtering step S1 is performed, that is, target ions within a fixed first target ion mobility range can be continuously moved on the specified path 8 from the first ion inlet 41 to the first ion outlet 43 (an end of the second channel away from the first ion transfer port 42), and can be continuously released from the end of the second channel CH2 away from the first ion transfer port 42.

Then, the ion dissociation step S2 is performed, that is, the ion dissociation device 6 receives the ions released from the first ion outlet 43 and dissociates the ions to generate fragment ions, and the obtained fragment ions are introduced into the second ion inlet 51 of the second U-shaped ion mobility analyzer 5 (an end of the third channel CH3 away from the second ion transfer port 52).

Finally, the fragment ion analysis step S3 is performed, that is, the power supply 3 applies the third direct current electric field E3 to the third channel CH3 of the second U-shaped ion mobility analyzer 5, and applies the fourth direct current electric field E4 to the fourth channel CH4 of the second U-shaped ion mobility analyzer 5. In one detection cycle, field strengths of the third direct current electric field E3 and the fourth direct current electric field E4 increase synchronously, and a field strength difference ΔE between the third direct current electric field E3 and the fourth direct current electric field E4 remains unchanged. In the process of synchronously increasing E3 and E4, the electric field strengths of main body parts of the third channel CH3 and the fourth channel CH4 are always kept to be different by ΔE, so that a full mobility range is scanned by a specific mobility window. The increase of E3 and E4 may be synchronous and gradual, or synchronous and step-wise. While the electric field strengths of the main body parts are increased, since an electric field strength on the right side of the first ion storage region 55 can be stably maintained at the highest value, and an electric field strength on the left side of the second ion storage region 56 can be stably maintained at the lowest value, as the third direct current electric field E3 is increased, the electric field strength in the first ion storage region 55 is reduced, a corresponding covered ion mobility range is reduced, ions in the first ion storage region 55 sequentially enter the target mobility range along with scanning of a mobility, and can move to the left along a length direction and be transmitted to the fourth channel CH4 through the second ion transfer port 52.

The second U-shaped ion mobility analyzer 5 operates in the filter-scan mode, and since ions not within the target mobility range can still be stored in the first ion storage region 55 or the second ion storage region 56, and the stored ions are released and utilized at a proper time, the fragment ions can basically be efficiently utilized to obtain a higher dynamic range. Moreover, with the first U-shaped ion mobility analyzer 4 operating in the filter-SIM mode, the second U-shaped ion mobility analyzer 5 can receive and analyze the fragment ions after the dissociation of the target ions without being set synchronously with the first U-shaped ion mobility analyzer 4.

The above embodiments are merely preferred embodiments of the present disclosure and are not intended to limit the present disclosure. Any modifications, equivalent substitutions and improvements made within the spirit and principles of the present disclosure shall be included in the protection scope of the present disclosure.

1. A tandem U-shaped ion mobility spectrometer, comprising:
a first U-shaped ion mobility analyzer configured to operate in a filter mode and including a first channel and a second channel, the first channel being provided with a first ion inlet, and the second channel being provided with a first ion outlet;
a second U-shaped ion mobility analyzer including a third channel and a fourth channel, the third channel being provided with a second ion inlet, the fourth channel being provided with a second ion outlet, and the second ion inlet being disposed corresponding to the first ion outlet;
a gas flow supply unit configured to supply gas flow to the first channel, the second channel, the third channel, and the fourth channel;
a power supply electrically connected to the first U-shaped ion mobility analyzer and the second U-shaped ion mobility analyzer and configured to apply an electric field force to ions in the first channel, the second channel, the third channel, and the fourth channel, the electric field force having a direction opposite to a direction of a force of the gas flow acting on the ions; and
an ion dissociation device configured to receive and dissociate ions from the first U-shaped ion mobility analyzer and release fragment ions generated by the dissociation device to the second U-shaped ion mobility analyzer.

2. The tandem U-shaped ion mobility spectrometer according to claim 1, wherein
the first channel, the second channel, the third channel and the fourth channel are disposed side by side in parallel to each other, and
a path of the gas flow generated by the gas flow supply unit includes four gas flow sub-paths along respectively the first channel, the second channel, the third channel and the fourth channel.

3. The tandem U-shaped ion mobility spectrometer according to claim 1, wherein
a path of the gas flow generated by the gas flow supply unit includes a gas flow path passing through both the first U-shaped ion mobility analyzer and the second U-shaped ion mobility analyzer.

4. The tandem U-shaped ion mobility spectrometer according to claim 3, wherein
the first U-shaped ion mobility analyzer includes a first ion through path from the first ion inlet to the first ion outlet, the second U-shaped ion mobility analyzer includes a second ion through path from the second ion inlet to the second ion outlet, and
the first ion through path and the second ion through path are disposed correspondingly to form an ion through path, and
the second channel and the third channel are respectively disposed on two sides of the ion through path, and are collinearly butted end-to-end along a length direction.

5. The tandem U-shaped ion mobility spectrometer according to claim 3, further comprising:
a housing including a first chamber, a second chamber and a gas flow guiding portion, wherein
the first chamber covers an outer surface of the first U-shaped ion mobility analyzer, and has one end provided with a gas flow inlet, and the other end in communication with the gas flow guiding portion, and a first through hole is provided in the first chamber at a position corresponding to the first ion outlet, and
the second chamber covers an outer surface of the second U-shaped ion mobility analyzer, and has one end provided with a gas flow outlet, and the other end in communication with the gas flow guiding portion, and a second through hole is provided in the second chamber at a position corresponding to the second ion inlet.

6. The tandem U-shaped ion mobility spectrometer according to claim 1, wherein the second U-shaped ion mobility analyzer operates in a filter mode.

7. The tandem U-shaped ion mobility spectrometer according to claim 6, wherein the first U-shaped ion mobility analyzer is configured in a filter-selected ion monitoring mode, and the second U-shaped ion mobility analyzer is configured in a filter-scan mode.

8. The tandem U-shaped ion mobility spectrometer according to claim 6, wherein both the first U-shaped ion mobility analyzer and the second U-shaped ion mobility analyzer are configured in a filter-selected ion monitoring mode.

9. The tandem U-shaped ion mobility spectrometer according to claim 1, wherein the ion dissociation device dissociates ions in a target region, and the target region is disposed between the first ion outlet and the second ion inlet.

10. The tandem U-shaped ion mobility spectrometer according to claim 1, wherein the ion dissociation device is one or more of a collision-induced dissociation device, an electron dissociation device, a free radical dissociation device, and a migratory dissociation device.

11. A U-shaped ion mobility analyzer, comprising:
a first channel including a first electrode array and a second electrode array which face each other in parallel;
a second channel including a third electrode array and a fourth electrode array which face each other in parallel, the first electrode array, the second electrode array, the third electrode array and the fourth electrode array being sequentially arranged side by side in parallel, the first electrode array including an ion inlet, the fourth electrode array including an ion outlet, the second electrode array and the third electrode array each including an ion through port and an ion transfer port, the ion through port, the ion inlet, and the ion outlet being correspondingly disposed, and the ion transfer port and the ion through port being arranged in a staggered manner;
a gas flow supply unit configured to supply gas flow to the first channel and the second channel;
a power supply electrically connected to the first electrode array, the second electrode array, the third electrode array, and the fourth electrode array and configured to apply an electric field force to ions in the first channel and the second channel, the electric field force having a direction opposite to a direction of a force of the gas flow acting on the ions; and
an ion dissociation device disposed between the two ion through ports, wherein
in a detection cycle, the power supply is configured to apply an electric field such that:
in a first time period, the U-shaped ion mobility analyzer is configured in a filter mode, and stores target ions obtained by the filtering in the second channel,
in a second time period after the first time period, the target ions stored in the second channel is dissociated by the ion dissociation device to obtain fragment ions, and the fragment ions are transferred back to the first channel, and
in a third time period after the second time period, ion mobility analysis is performed on the fragment ions by causing the fragment ions to pass through a specified path sequentially from the first channel, the ion transfer port, the second channel, to the ion outlet.

12. An ion mobility analysis method, comprising:
an ion filtering step of filtering, by a first U-shaped ion mobility analyzer configured in a filter mode, target ions having ion mobility within a target mobility range from an ion beam;
an ion dissociation step of receiving and dissociating the target ions filtered by the first U-shaped ion mobility analyzer to obtain fragment ions corresponding to the target ions; and
a fragment ion analysis step of performing ion mobility analysis on the fragment ions.

13. The ion mobility analysis method according to claim 12, wherein the fragment ion analysis step is performed by a second U-shaped ion mobility analyzer.

14. The ion mobility analysis method according to claim 13, wherein the first U-shaped ion mobility analyzer is configured in a filter-selected ion monitoring mode, and the second U-shaped ion mobility analyzer is configured in a filter-scan mode.

15. The ion mobility analysis method according to claim 13, wherein both the first U-shaped ion mobility analyzer and the second U-shaped ion mobility analyzer are configured in a filter-selected ion monitoring mode.

16. The ion mobility analysis method according to claim 12, wherein
the fragment ion analysis step is performed by the first U-shaped ion mobility analyzer, and an ion dissociation device performing the ion dissociation step is disposed between two ion through ports of the first U-shaped ion mobility analyzer,
in the ion filtering step, the target ions are stored in a second channel of the first U-shaped ion mobility analyzer,
in the ion dissociation step, the target ions stored in the second channel are dissociated to obtain the fragment ions when passing through the ion through ports, and the fragment ions are transferred back to a first channel of the first U-shaped ion mobility analyzer, and
in the fragment ion analysis step, the ion mobility analysis is performed on the fragment ions by causing the fragment ions to pass through a specified path sequentially from the first channel to the second channel.
